(19) United States
(12) Patent Application Publication
(10) Pub. No.: US 2015/0134485 A1
(43) Pub. Date: May 14, 2015

(54) CLOUD SERVICE BROKER APPARATUS AND METHOD FOR PROVIDING CLOUD SERVICE USING THE SAME

(71) Applicant: ELECTRONICS AND TELECOMMUNICATIONS RESEARCH INSTITUTE, Daejeon-city (KR)

(72) Inventors: Jin-Mee KIM, Daejeon (KR); Sung-In JUNG, Daejeon (KR); Dong-Jae KANG, Daejeon (KR); Nam-Woo KIM, Daejeon (KR)

(73) Assignee: ELECTRONICS AND TELECOMMUNICATIONS RESEARCH INSTITUTE, Daejeon-city (KR)

(21) Appl. No.: 14/532,136

(22) Filed: Nov. 4, 2014

(30) Foreign Application Priority Data
Nov. 8, 2013 (KR) 10-2013-0135551

(51) Int. Cl. H04L 12/24; G06Q 30/06

(52) U.S. Cl. CPC H04L 41/5051; G06Q 30/0613; H04L 41/5006; G06Q 30/0623
USPC 705/26.41

(57) ABSTRACT

Disclosed herein is a cloud service broker apparatus and method for providing a cloud service using the broker apparatus, which provide an optimal cloud service for a cloud service user through negotiations between the cloud service user and a cloud service provider. The cloud service broker apparatus includes an operation information management unit for examining a demand entered by a cloud service user. A broker intermediary unit detects a cloud service based on the demand for which verification has been completed by the operation information management unit, and sends a request for positioning of the cloud service for the cloud service user to a cloud service provider that provides the detected cloud service. A life cycle management unit monitors a cloud service positioned in and used by the cloud service user at a request of the broker intermediary unit.

### CROSS REFERENCE TO RELATED APPLICATION

This application claims the benefit of Korean Patent Application No. 10-2013-0135551, filed Nov. 8, 2013, which is hereby incorporated by reference in its entirety into this application.

### BACKGROUND OF THE INVENTION

1. Technical Field

The present invention relates generally to a cloud service broker apparatus and a method for providing a cloud service using the broker apparatus and, more particularly, to a cloud service broker apparatus and a method for providing a cloud service using the broker apparatus, which intermediate and coordinate services through negotiations between a cloud service user (or cloud service consumer) and a cloud service operator (or cloud service provider) upon connecting, integrating, and managing cloud resources to trade a cloud infrastructure service that builds a virtual environment with Information Technology (IT) infrastructure equipment, such as servers, storage, or network equipment, and borrows the IT infrastructure equipment as necessary in multiple cloud environments.

2. Description of the Related Art

As well known to those skilled in the art, cloud services are divided into Software-as-a-Service (Saas) to provide applications to the user, Platform-as-a-Service (PaaS) to provide platforms (that is, operating systems, such as Windows and Linux) to the user, Hardware-as-a-Service (Haas) to provide hardware to the user, Infrastructure-as-a-Service (IaaS) to create a virtualized environment with servers, storage, and networks and provide the virtualized environment to the user, etc., based on service characteristics.

However, the conventional cloud service provides a cloud service provider-oriented cloud infrastructure service without negotiation between the cloud service user and the cloud service provider. Thus, the conventional cloud service has a problem in terms of being unable to prove an optimal service desired by the cloud service user. In other words, the conventional cloud service has difficulty in providing reasonable cloud services in cooperation with different cloud service providers in the process of selecting and allocating resources and has a problem with providing user-oriented optimal and reasonable services, because the cloud service providers unilaterally provide infrastructure services.

In addition, a problem arises in that it is hard for the conventional cloud service to support urgent computing resource demands unexpected by the cloud service user, because services are not smoothly connected to each other due to an absence of negotiation. In connection with this, Korean Patent Application Publication No. 10-2012-0116773 discloses a technology related to “Cloud Computing Service Center Recommendation Method” and U.S. Patent Application Publication No. 2013-0110913 discloses a technology related to “Apparatus and Method for Providing Distributed Cloud Service”.

### SUMMARY OF THE INVENTION

Accordingly, the present invention has been made keeping in mind the above problems occurring in the conventional art, and an object of the present invention is to provide a cloud service broker apparatus and method for providing a cloud service using the broker apparatus, which provide of an optimized cloud service to a cloud service user through negotiations between the cloud service user and a cloud service provider.

In other words, the present invention is intended to provide a cloud service broker apparatus and a method for providing a cloud service using the broker apparatus, which provide a cloud service optimized for a cloud service user by detecting the optimized cloud service based on demands of the cloud service user and leading to negotiations between the cloud service user and a cloud service provider through coordination of the demands if there is no cloud service optimized for the demands.

Another object of the present invention is to provide a cloud service broker apparatus and a method for providing a cloud service using the broker apparatus, which take charge of service management by playing an intermediary unit role between a cloud service user and a cloud service provider and which enable cloud services from multiple cloud service providers to be reliably and seamlessly provided to the cloud service user.

In other words, the present invention is intended to provide a cloud service broker apparatus and a method for providing a cloud service using the broker apparatus, which provide convenience in service usage by coordinating relationships between a cloud service provider and a cloud service user, proposing an optimal cloud infrastructure service that meets consumer demands, helping utilization of various cloud services, and taking charge of service performance management and service delivery.

In accordance with an aspect of the present invention to accomplish the above objects, there is provided a cloud service broker apparatus, including an operation information management unit for verifying a demand entered by a cloud service user; a broker intermediary unit for detecting a cloud service based on the demand for which verification has been completed by the operation information management unit, and requesting a cloud service provider that provides the detected cloud service to position the cloud service for the cloud service user; and a life cycle management unit for monitoring a cloud service positioned in and used by the cloud service user at a request of the broker intermediary unit.

The operation information management unit may include a service registration module for registering cloud services of multiple cloud service providers based on a Service Level Agreement (SLA); a broker portal module for receiving, from a cloud service user, a demand that includes at least one of a cloud's position, usage expenses, reliability, system resource specification, and operating system; a demand verification module for performing verification including at least one of verification of grammatical mistakes of the demand entered through the broker portal module and verification of whether the demand corresponds to a supportable cloud service, based on cloud services registered through the service registration module; and an operation information storage module for storing results of monitoring a cloud service in the life cycle management unit.

The broker intermediary unit may include a service positioning negotiation module for detecting a cloud service corresponding to the demand from among the multiple cloud services registered by the operation information management unit and performing a trade contract between a cloud service provider that provides the detected cloud service and a cloud service user; an optimal resource selection module for configuring a service specification of the cloud service for which the trade contract has been completed by the service positioning negotiation module; and a service positioning module for requesting a cloud service provider to allocate the cloud service based on the service specification configured by the optimal resource selection module.

The service positioning negotiation module may re-detect a cloud service by modifying the demand through negotiations with the cloud service user if no cloud service corresponding to the demand has been detected.

The service positioning module may request the cloud service provider to allocate a cloud service including at least one of server resources, storage resources, network resources, and installation and configuration of an application service designated by the cloud service user.

The life cycle management unit may include a service/resource monitoring module for monitoring and managing status of a cloud service contracted between a cloud service user and a cloud service provider and resource status of the cloud service.

The life cycle management unit may include a service management/control module for monitoring status of a service for a cloud service user, the service being positioned and performed in the cloud service provider at a request of the broker intermediary unit; and a service resource management module for monitoring status of resources of cloud services positioned and performed in a cloud service provider at the request of the broker intermediary unit, the resources including at least one of server resources, storage resources, and network resources.

The cloud service broker apparatus may further include a connection management unit for managing connections between multiple cloud service providers that provide heterogeneous cloud services and a cloud service user.

The connection management unit may include a common cloud interface module for providing a single interface that connects to multiple cloud services provided by the multiple cloud service providers; and a heterogeneous cloud connection proxy module for switching an interface from the single interface provided by the common cloud interface module to an interface of a cloud service.

The cloud service broker apparatus may further include a business support unit for managing usage of the cloud service based on monitoring results of the life cycle management unit and charging cloud service usage expenses to the cloud service user.

The cloud service broker apparatus may further include an application image management unit for storing and managing an image of an application run by a cloud service positioned in and used by the cloud service user at a request of the broker intermediary unit.

The cloud service broker apparatus may further include a security unit for authenticating a cloud service user and a cloud service provider and examining security vulnerability of each cloud service registered by the operation information management unit.

In accordance with another aspect of the present invention to accomplish the above objects, there is provided a method for providing a cloud service using a service broker apparatus, including registering, by the cloud service broker apparatus, cloud services provided from multiple cloud service providers; receiving, by the cloud service broker apparatus, a demand from a cloud service user; verifying, by the cloud service broker apparatus, the demand; detecting, by the cloud service broker apparatus, a cloud service that corresponds to the demand for which the verification has been completed from among the registered multiple cloud services; and providing, by the cloud service broker apparatus, the detected cloud service by connecting an interface between the detected cloud service and the cloud service user.

Receiving the demand from the cloud service user may include receiving, by the cloud service broker apparatus, a demand that includes at least one of a cloud's position, usage expenses, reliability, system resource specification, and operating system.

Verifying the demand may include performing, by the cloud service broker apparatus, verification including at least one of verification of grammatical mistakes of the demand and verification of whether the demand corresponds to a supportable cloud service.

Detecting the cloud service may include modifying, by the cloud service broker apparatus, the demand through negotiations with the cloud service user if no cloud service corresponding to the demand has been detected; re-verifying, by the cloud service broker apparatus, the modified demand; and detecting, by the cloud service broker apparatus, a cloud service corresponding to the demand for which re-verification has been completed.

Detecting the cloud service may include performing, by the cloud service broker apparatus, a trade contract for the detected cloud service between the cloud service user and the cloud service provider; configuring, by the cloud service broker apparatus, a service specification of the cloud service for which the trade contract has been completed; and requesting, by the cloud service broker apparatus, the cloud service provider to allocate the cloud service based on the service specification.

The method may further include monitoring, by the cloud service broker apparatus, status of the provided cloud service and resource status of the cloud service.

Monitoring the status of the cloud service and resource status of the cloud service may include if the monitored status of the cloud service becomes inconsistent with terms of a Service Level Agreement (SLA), re-subscribing or re-positioning, by the cloud service broker apparatus, a cloud service.

The method may further include charging, by the cloud service broker apparatus, cloud service usage expenses based on the monitoring results.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a cloud service broker apparatus according to an embodiment of the present invention;

FIG. 2 is a block diagram showing the configuration of a cloud service broker apparatus according to an embodiment of the present invention;

FIG. 3 is a diagram illustrating an operation information management unit shown in FIG. 2;

FIG. 4 is a diagram illustrating a broker intermediary unit shown in FIG. 2;

FIG. 5 is a diagram illustrating a life cycle management unit shown in FIG. 2;

FIG. 6 is a diagram illustrating a connection management unit shown in FIG. 2;

FIG. 7 is a diagram illustrating an application image management unit of FIG. 2;

FIG. 8 is a diagram illustrating a security unit shown in FIG. 2;

FIG. 9 is a diagram illustrating a business support unit shown in FIG. 2;

FIG. 10 is a flowchart illustrating a method for providing a cloud service using a cloud service broker apparatus according to an embodiment of the present invention; and

FIG. 11 is a flowchart illustrating a cloud service detection step shown in FIG. 10.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. It should be noted that the same reference numerals are used to designate the same or similar elements throughout the drawings. In the following description of the present invention, detailed descriptions of known functions and configurations which are deemed to make the gist of the present invention obscure will be omitted.

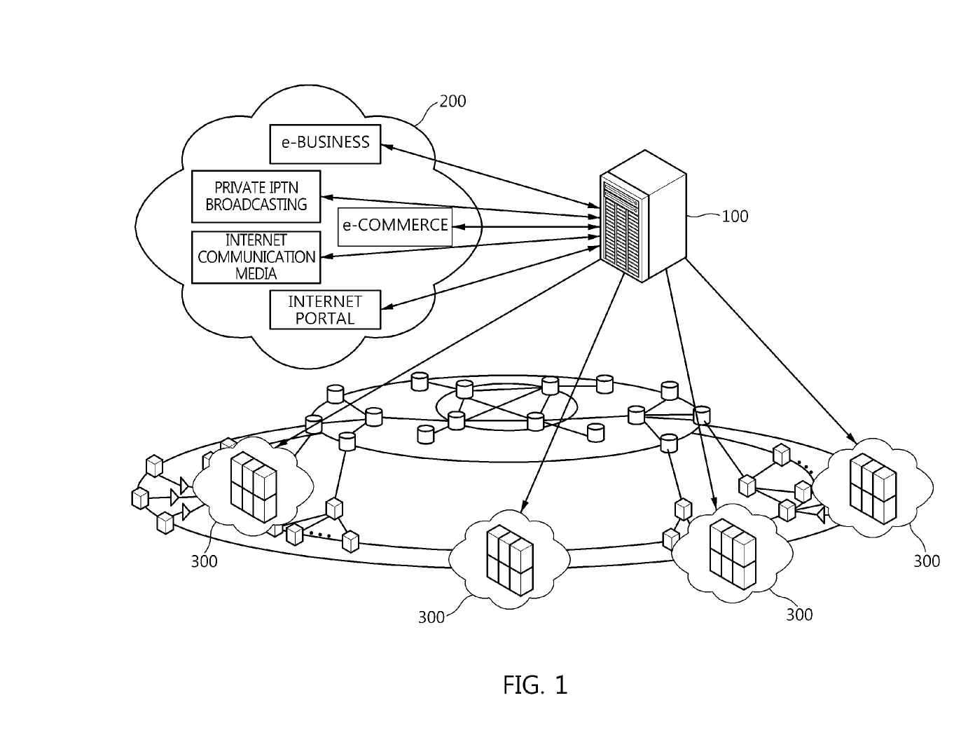

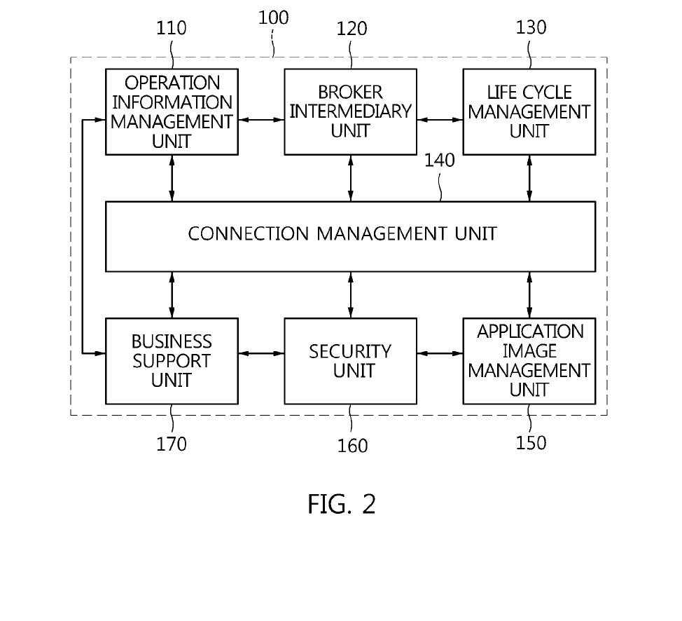

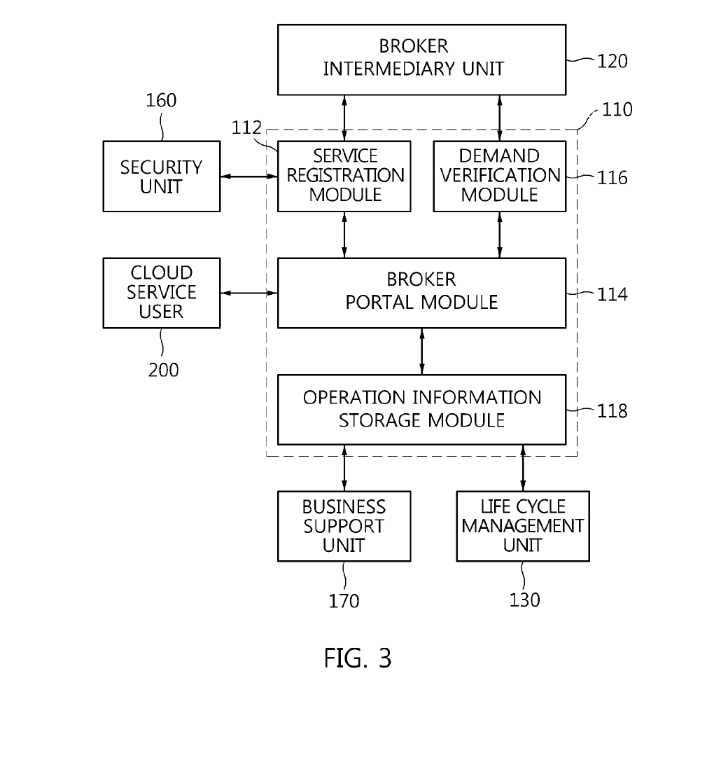

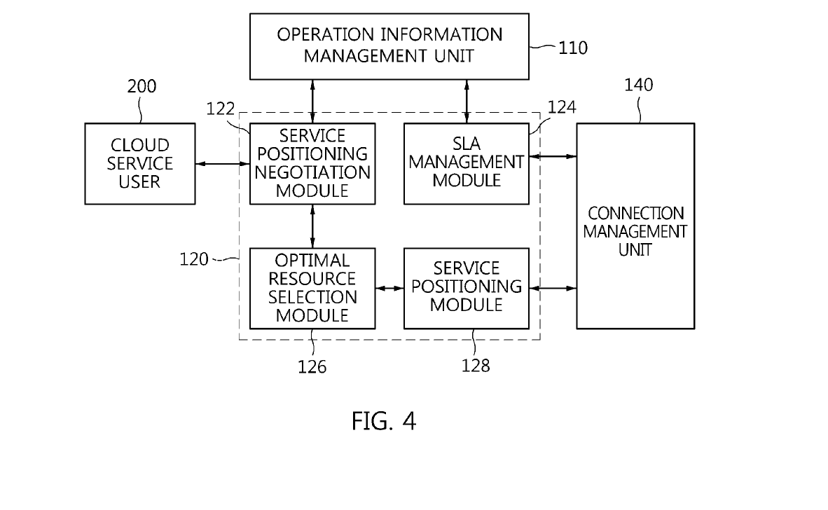

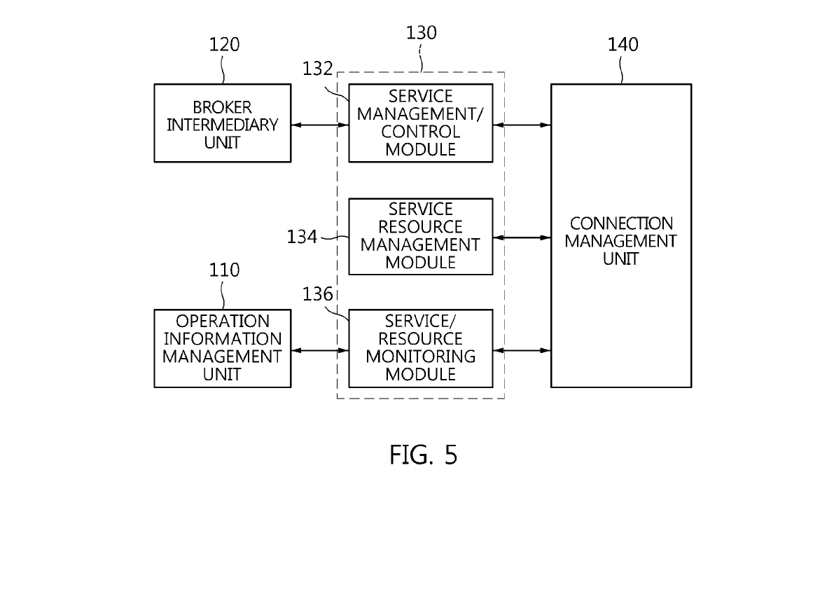

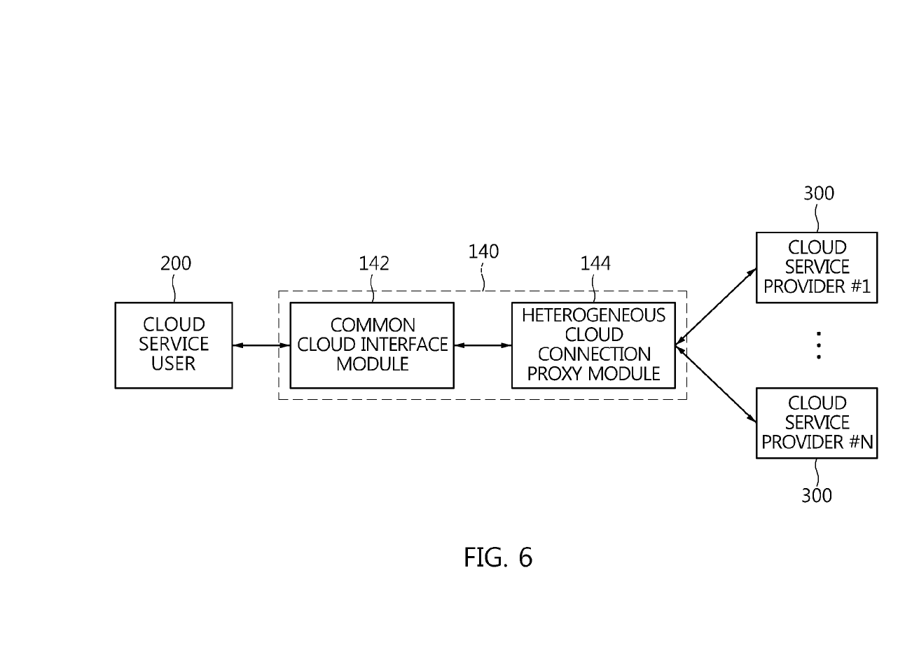

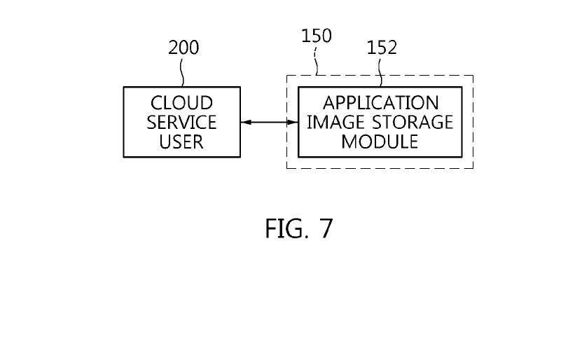

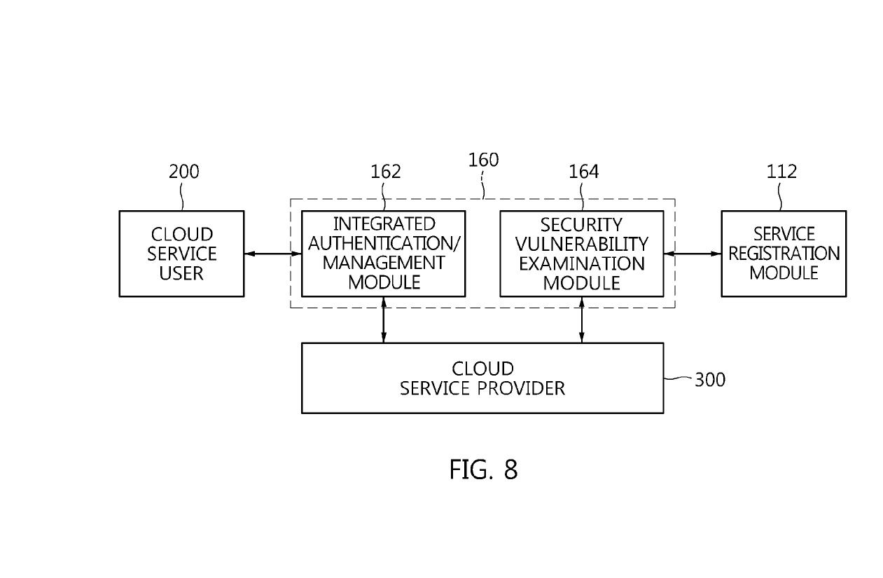

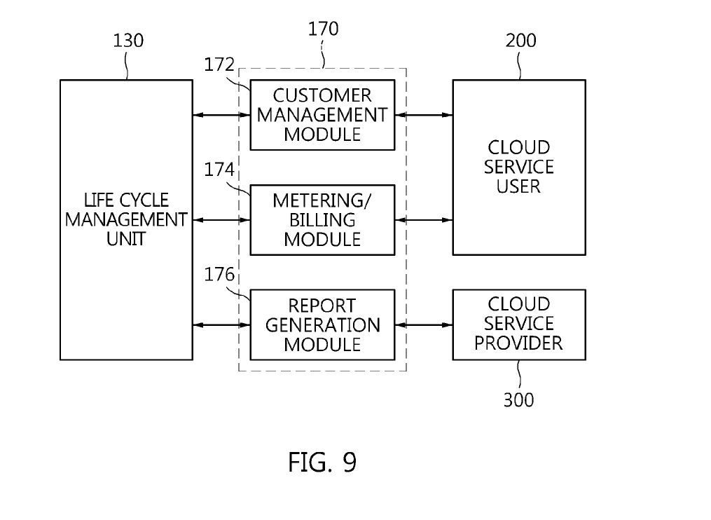

Hereinafter, a cloud service broker apparatus according to an embodiment of the present invention will be described in detail with reference to accompanying drawings. FIG. 1 is a diagram illustrating a cloud service broker apparatus according to an embodiment of the present invention, and FIG. 2 is a block diagram showing the configuration of a cloud service broker apparatus according to an embodiment of the present invention. FIG. 3 is a diagram illustrating an operation information management unit shown in FIG. 2, FIG. 4 is a diagram illustrating a broker intermediary unit shown in FIG. 2, and FIG. 5 is a diagram illustrating a life cycle management unit shown in FIG. 2. FIG. 6 is a diagram illustrating a connection management unit shown in FIG. 2, FIG. 7 is a diagram illustrating an application image management unit of FIG. 2, FIG. 8 is a diagram illustrating a security unit shown in FIG. 2, and FIG. 9 is a diagram illustrating a business support unit shown in FIG. 2.

As shown in FIG. 1, a cloud service broker apparatus 100 provides cloud services offered by multiple cloud service providers (or cloud service operators) 300 to multiple cloud service users 200. That is, the cloud service broker apparatus 100 coordinates relationships between the cloud service users 200 and the cloud service providers 300 and provides an optimal cloud service that meets user demands. The cloud service broker apparatus 100 takes charge of utilization, performance management, service delivery, etc. of cloud services. The cloud service broker apparatus 100 provides, compares, and analyzes integrated information, such as performance, cost, security, position, and infrastructures, provided by individual clouds, in order to select the best cloud suited to a purpose of the cloud service user 200. The cloud service broker apparatus 100 builds an integrated environment for accessing, using, and managing complicated multiple cloud services in the same manner and then activates cloud services. For this, as shown in FIG. 2, the cloud service broker apparatus 100 is configured to include an operation information management unit 110, a broker intermediary unit 120, a life cycle management unit 130, a connection management unit 140, an application image management unit 150, a security unit 160, and a business support unit 170.

The operation information management unit 110 manages operation information related to the provision of a cloud service. That is, the operation information management unit 110 manages the operation information of each cloud service provider 300 and each cloud service user 200. The operation information management unit 110 registers and manages cloud services provided by multiple cloud service providers 300. The operation information management unit 110 connects the cloud service users 200 and the cloud service providers 300, and then has a contract for and manages cloud services. The operation information management unit 110 receives demands from the service user 200 and verifies the demands. The operation information management unit 110 collects and stores operation information based on the use of cloud services. For these operations, as shown in FIG. 3, the operation information management unit 110 is configured to include a service registration module 112, a broker portal module 114, a demand verification module, and an operation information storage module 118.

The service registration module 112 registers cloud services. Specifically, the service registration module 112 registers cloud services that the cloud service provider 300 may provide to the cloud service user 200. In this regard, the service registration module 112 registers the cloud services based on a Service Level Agreement (SLA) clause defined by a cloud service broker (CSB). Here, the service registration module 112 registers the cloud services based on the SLA, which is registered and managed by the broker intermediary unit 120.

The broker portal module 114 interfaces the functionality of a cloud service broker between the cloud service user 200 and the cloud service provider 300. That is, the cloud service user 200 has a contract for and uses a cloud service provided by a service operator through the broker portal module 114. Specifically, the cloud service provider 300 registers a cloud service to be provided to the cloud service user 200 through the broker portal module 114. A cloud service broker manager manages the current status of a cloud service being traded through the broker portal module 114 and controls the cloud service broker functionality.

The broker portal module 114 receives demands from the cloud service user 200. In this regard, the demands may include the cloud's position, usage cost, reliability, specification of system resources, operating system, etc.

The demand verification module 116 verifies the demands of the cloud service user 200 entered through the broker portal module 114. Specifically, the demand verification module 116 verifies grammatical mistakes of the demands entered by the cloud service user 200, whether the demands corresponds to a supportable cloud service, etc. In this regard, the demand verification module 116 verifies whether the SLA-based demands of the cloud service user 200 to be used in searching for a cloud service conform to an SLA clause provided by the CSB.

The operation information storage module 118 stores operation information related to a cloud service contracted with the cloud service user 200. Specifically, the operation information storage module 118 stores operation information for a cloud service monitored by the life cycle management unit 130 (that is, monitored data including the status of the cloud service and the resource status of the cloud service). The operation information storage module 118 collects operation information from multiple cloud service providers 300 through the connection management unit 140, and stores the operation information. The collected operation information may be utilized by the business support unit 170 for supporting businesses, such as consumer management, billing, and service reporting.

The broker intermediary unit 120 detects a cloud service based on the demands of the cloud service user 200. If there is no cloud service that meets the user demands, the broker intermediary unit 120 detects a suitable cloud service through negotiations between the cloud service user 200 and the cloud service provider 300. The broker intermediary unit 120 requests the allocation of the detected cloud service from the cloud service user 200. For this, as shown in FIG. 4, the broker intermediary unit 120 is configured to include a service positioning negotiation module 122, an SLA management module 124, an optimal resource selection module 126, and a service positioning module 128.

The service positioning negotiation module 122 detects a cloud service based on the demands for which verification has been completed by the operation information management unit 110. That is, the service positioning negotiation module 122 detects a cloud service that best meets the verified demands from among cloud services registered by the cloud service provider 300 through the operation information management unit 110. If there is no cloud service that meets the demands, the service positioning negotiation module 122 modifies the demands through negotiations with the cloud service user 200 and then re-detects a cloud service. The service positioning negotiation module 122 performs a trade contract between the cloud service provider 300 that provides the detected cloud service and the cloud service user 200 that enters the demands.

The SLA management module 124 registers and manages an SLA. Specifically, the SLA management module 124 receives an SLA policy of a cloud service from the cloud service provider 300, and registers and manages the SLA policy.

Once the trade contract between the cloud service user 200 and the cloud service provider 300 is completed by the service positioning negotiation module 122, the optimal resource selection module 126 fixes the detected cloud service as the cloud service to be provided to the cloud service user 200. The optimal resource selection module 126 configures a service specification of the fixed cloud service.

The service positioning module 128 requests the allocation of a cloud service from the cloud service provider 300 based on the service specification created by the optimal resource selection module 126. In this regard, the service positioning module 128 requests the allocation of the cloud service from the cloud service provider 300 through the connection management unit 140. Here, the service positioning module 128 requests the allocation of the cloud service which includes server, storage, and network resources, and the installation and configuration of an application service designated by the cloud service user 200.

The life cycle management unit 130 monitors the status of the cloud service positioned in the cloud service user 200, the resource status of the cloud service, etc. For this, as shown in FIG. 5, the life cycle management unit 130 is configured to include a service management/control module 132, a service resource management module 134, and a service and resource monitoring module 136.

The service management/control module 132 monitors the status of a service of the cloud service user 200 at the request of the broker intermediary unit 120, the service being positioned and performed in the cloud service provider 300. The service management/control module 132 controls and manages a cloud service based on an SLA clause. If the status of the cloud service becomes inconsistent with the terms of the SLA clause, the service management/control module 132 performs a predetermined process.

The service resource management module 134 monitors the resource status of cloud services being positioned and performed in the cloud service provider 300. The service resource management module 134 monitors the resource status of the cloud services including the status of server resources, storage resources, and network resources.

The service/resource monitoring module 136 monitors and manages the status of a cloud service contracted between the cloud service user 200 and the cloud service provider 300 and resource status of the cloud service. In this regard, the service/resource monitoring module 136 collects the status of the cloud service and the resource status of the cloud service from the cloud service provider 300 through the connection management unit 140. The service/resource monitoring module 136 sends the collected status of the cloud service and resource status of the cloud service to the operation information management unit 110 (that is, the operation information storage module 118) and the business support unit 170.

The connection management unit 140 manages connection between heterogeneous cloud services provided by the multiple cloud service providers 300 and the cloud service user 200. In other words, cloud services provided by the multiple cloud service users 300 provide different interfaces. Accordingly, the connection management unit 140 provides an interface for connection between cloud services that use heterogeneous interfaces and the cloud service user 200. For this, as shown in FIG. 6, the connection management unit 140 is configured to include a common cloud interface module 142 and a heterogeneous cloud connection proxy module 144.

The common cloud interface module 142 provides a single interface to connect to multiple cloud services provided by the multiple cloud service providers 300. That is, the common cloud interface module 142 connects the cloud service user 200 and the multiple cloud services linked to different interfaces through the single interface.

The heterogeneous cloud connection proxy module 144 switches an interface from the single interface provided by the common interface module 142 to an interface for a cloud service. In other words, the heterogeneous cloud connection proxy module 144 switches an interface from the single interface of the cloud service user 200 to an interface of a cloud service being used by the cloud service user 200.

The application image management unit 150 stores application images of the cloud service user 200. For this, as shown in FIG. 7, the application image management unit 150 is configured to include an application image storage module 152. The application image storage module 152 stores and manages images of applications that the cloud service user 200 intends to run using a cloud service. In this regard, the application image storage module 152 stores and manages application images by receiving them from the cloud service user 200. The application image storage module 152 also stores and manages information regarding a setting procedure for automatic configuration settings of the application image.

The security unit 160 authenticates the cloud service user 200 and the cloud service provider 300, and examines security vulnerabilities of a cloud service. For this, as shown in FIG. 8, the security unit 160 is configured to include an integrated authentication/management module 162 and a security vulnerability examination module 164.

The integrated authentication/management module 162 authenticates the cloud service user 200, the cloud service provider 300, and a cloud service broker manager. Specifically, the integrated authentication/management module 162 manages IDs and passwords of the cloud service user 200, the cloud service provider 300, and the cloud service broker manager, which are used to access the cloud service broker apparatus 100. The integrated authentication/management module 162 authenticates the cloud service user 200, the cloud service provider 300, and the cloud service broker manager by comparing entered information (that is, ID and password) with managed information. The integrated authentication/management module 162 performs account management for the cloud service user 200 and the cloud service provider 300 in response to their access to the cloud service broker apparatus 100 and a cloud service with a single ID.

The security vulnerability examination module 164 examines security vulnerability in registering a cloud service. That is, the security vulnerability examination module 164 examines the security vulnerability of each cloud service registered through the operation information management unit 110.

The business support unit 170 charges cloud service expenses based on the monitoring results of the life cycle management unit 130 and manages the use of services. For this, as shown in FIG. 9, the business support unit 170 is configured to include a customer management module 172, a metering/billing module 174, and a report generation module 176.

The customer management module 172 provides the cloud service user 200 with information regarding the service usage status of the cloud service user 200, current operation status, etc., based on the monitored data (that is, the status of the cloud service and the resource status of the cloud service) collected by the life cycle management unit 130. The customer management module 172 may also collect and manage evaluation information for a used cloud service from the client service user 200.

The metering/billing module 174 calculates the amount of resources (resource usage data) used by the cloud service user 200 based on the monitored data collected by the life cycle management unit 130. The metering/billing module 174 charges service usage expenses to the cloud service user 200 based on the calculated resource usage data.

The report generation module 176 generates a report that contains the current status of service operation of the cloud service provider 300, an SLA conformity level, etc., based on the monitored data collected by the life cycle management unit 130. The report generation module 176 provides the generated report to the cloud service provider 300.

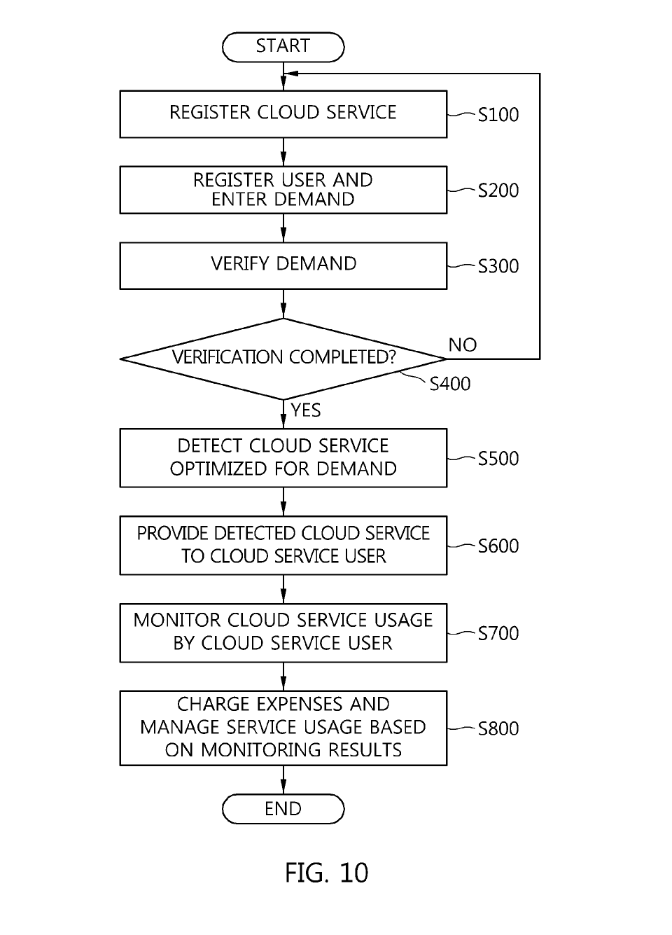

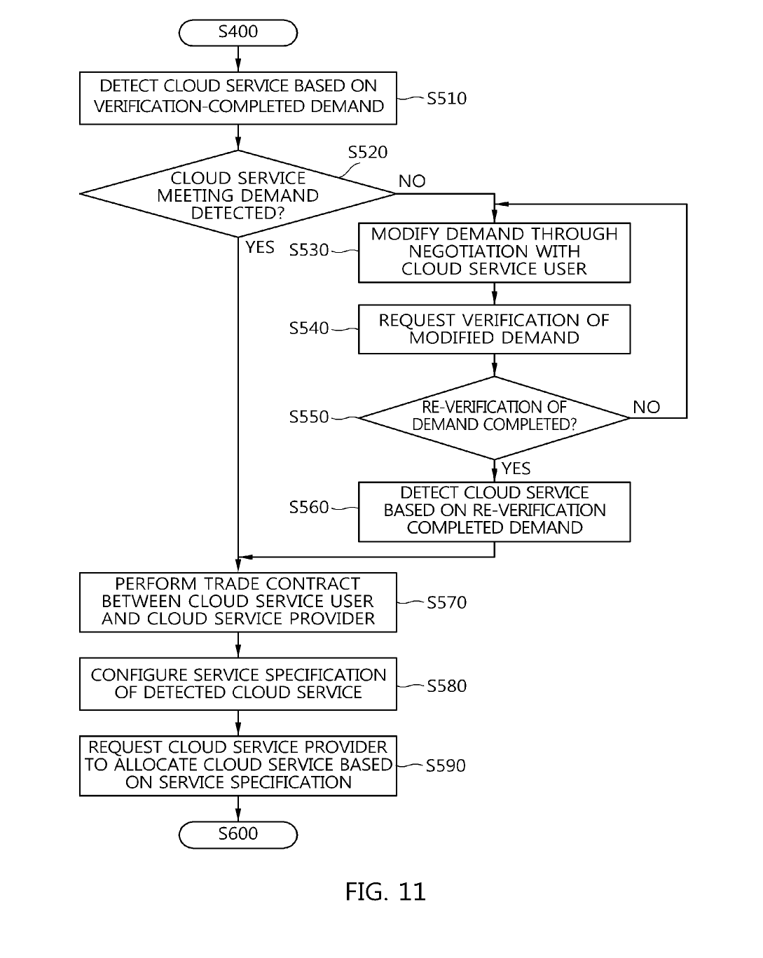

Hereinafter, a method for providing a cloud service using the cloud service broker apparatus in accordance with an embodiment of the present invention will be described in detail with reference to the accompanying drawings. FIG. 10 is a flowchart illustrating a method for providing a cloud service using the cloud service broker apparatus according to an embodiment of the present invention, and FIG. 11 is a flowchart illustrating a cloud service detection step shown in FIG. 10.

The operation information management unit 110 registers cloud services provided from multiple cloud service providers 300 at step S100. That is, the operation information management unit 110 registers the cloud services based on an SLA clause defined by a CSB. At this time, the security unit 160 examines the security vulnerabilities of the cloud services registered through the operation information management unit 110.

After user registration for each cloud service user 200 has been completed, the operation information management unit 110 receives demands from the corresponding cloud service user 200 at step S200. In a case where the cloud service user 200 has already been registered, the operation information management unit 110 receives an ID and password from the cloud service user 200 and requests the security unit 160 to authenticate the cloud service user. Accordingly, the security unit 160 performs user authentication by comparing the received ID and password with managed information. Once the user authentication is successfully performed by the security unit 160, the operation information management unit 110 receives demands, including a cloud's position, usage expense, reliability, system resource specification, operating system, etc., from the cloud service user 200.

The operation information management unit 110 verifies the received demands at step S300. Specifically, the operation information management unit 110 verifies grammatical mistakes of the demands entered by the cloud service user 200, whether the demands correspond to a supportable cloud service, etc. In this regard, the operation information management unit 110 verifies whether the SLA-based demands from the cloud service user 200 to be used in searching for a cloud service conform to an SLA clause provided by the CSB.

After the verification of the demands has been completed (“Yes” at step S400), the broker intermediary unit 120 detects a cloud service optimized for the demands at step S500. The broker intermediary unit 120 may detect a cloud service optimized based on terms, such as optimum costs and performance, depending on the demands. In this regard, the broker intermediary unit 120 intermediates SLA agreements between the cloud service provider 300 and the cloud service user 200. This will be described below in more detail with reference to FIG. 11.

Referring to FIG. 11, the broker intermediary unit 120 detects a cloud service based on the demands for which verification has been completed at step S510. If any cloud service that meets the demands has not been detected at step S520, the broker intermediary unit 120 modifies the demands through negotiations with the cloud service user 200 at step S530.

Thereafter, the broker intermediary unit 120 requests the operation information management unit 110 to re-verify the modified demands at step S540. When the re-verification of the modified demands has been completed by the operation information management unit 110 (“Yes” at step S550), the broker intermediary unit 120 re-detects a cloud service that meets the modified demands at step S560.

The broker intermediary unit 120 performs a trade contract for the detected cloud service between the cloud service provider 200 and the cloud service user 300 at step S570.

If the trade contract has been made, the broker intermediary unit 120 configures a service specification of the detected cloud service at step S580.

The broker intermediary unit 120 requests the cloud service provider 300 to allocate the cloud service based on the service specification at step S590. That is, the broker intermediary unit 120 checks the cloud service to be positioned in the cloud service user 200, and then requests the positioning of the cloud service. Accordingly, the connection management unit 140 makes connection to the cloud service provider 300 that provides the cloud service, and then requests the cloud service provider 300 to position the cloud service.

If the allocation of the cloud service has been completed by the cloud service provider 300, the connection management unit 140 allows an interface to be connected between the cloud service and the cloud service user 200, thus providing the cloud service allocated by the cloud service provider 300 to the cloud service user 200 at step S600.

The life cycle management unit 130 monitors the usage of the cloud service by the cloud service user 200 at step S700. Specifically, the life cycle management unit 130 monitors and manages the status of the cloud service contracted between the cloud service user 200 and the cloud service provider 300 and the resource status of the cloud service. In this regard, the life cycle management unit 130 collects the status of the cloud service and the resource status of the cloud service from the cloud service provider 300 through the connection management unit 140. The life cycle management unit 130 sends the collected status of the cloud service and resource status of the cloud service to the operation information management unit 110, that is, to the operation information storage module 118 and the business support unit 170. If the status of the cloud service becomes inconsistent with the terms of the SLA clause, depending on the usage of the cloud service user 200, the life cycle management unit 130 performs a predetermined process. For example, the life cycle management unit 130 requests re-subscription to a cloud service or the re-positioning of a cloud service from the broker intermediary unit 120 in an abnormal situation, such as in violation of SLA terms, the use of excessive resources, or service inaccessibility.

The business support unit 170 charges the cloud service expenses based on the monitoring results and manages service usage at step S800. The business support unit 170 provides the cloud service user 200 with information regarding the service usage state of the cloud service user 200, the current status of service operation, etc., based on the monitored data (that is, the status of the cloud service and the resource status of the cloud service) collected by the life cycle management unit 130. The business support unit 170 may also collect and manage evaluation information for a used cloud service from the client service user 200. The business support unit 170 calculates the amount of resources used by the cloud service user 200 (resource usage data) based on the monitored data collected by the life cycle management unit 130. The business support unit 170 charges the service usage expenses to the cloud service user 200 based on the calculated resource usage data. The business support unit 170 generates a report that contains the current status of service operation of the cloud service provider 300, the SLA conformity level, etc., based on the monitored data collected by the life cycle management unit 130. The business support unit 170 provides the generated report to the cloud service provider 300.

As described above, the cloud service broker apparatus and the method for providing a cloud service using the broker apparatus have an advantage of providing a cloud service optimized for demands of a cloud service user by providing the optimized cloud service to the cloud service user through negotiations between the cloud service user and a cloud service provider.

Furthermore, the cloud service broker apparatus and the method for providing a cloud service using the broker apparatus have another advantage of mitigating the complexity of service usage between a cloud service user and a cloud service provider and providing a service optimized for user demands in multiple cloud environments by providing the optimized cloud service to the cloud service user through negotiations between the cloud service user and the cloud service provider.

Although the preferred embodiments of the present invention have been disclosed, the present invention may be modified in various forms, and those skilled in the art will practice various modifications and changes, without departing from the scope and spirit of the invention as disclosed in the accompanying claims.

What is claimed is:

1. A cloud service broker apparatus, comprising:
an operation information management unit for verifying a demand entered by a cloud service user;
a broker intermediary unit for detecting a cloud service based on the demand for which verification has been completed by the operation information management unit, and requesting a cloud service provider that provides the detected cloud service to position the cloud service for the cloud service user; and
a life cycle management unit for monitoring a cloud service positioned in and used by the cloud service user at a request of the broker intermediary unit.

2. The cloud service broker apparatus of claim 1, wherein the operation information management unit comprises:
a service registration module for registering cloud services of multiple cloud service providers based on a Service Level Agreement (SLA);
a broker portal module for receiving, from a cloud service user, a demand that includes at least one of a cloud's position, usage expenses, reliability, system resource specification, and operating system;
a demand verification module for performing verification including at least one of verification of grammatical mistakes of the demand entered through the broker portal module and verification of whether the demand corresponds to a supportable cloud service, based on cloud services registered through the service registration module; and
an operation information storage module for storing results of monitoring a cloud service in the life cycle management unit.

3. The cloud service broker apparatus of claim 1, wherein the broker intermediary unit comprises:
a service positioning negotiation module for detecting a cloud service corresponding to the demand from among the multiple cloud services registered by the operation information management unit and performing a trade contract between a cloud service provider that provides the detected cloud service and a cloud service user;
an optimal resource selection module for configuring a service specification of the cloud service for which the trade contract has been completed by the service positioning negotiation module; and
a service positioning module for requesting a cloud service provider to allocate the cloud service based on the service specification configured by the optimal resource selection module.

4. The cloud service broker apparatus of claim 3, wherein the service positioning negotiation module re-detects a cloud service by modifying the demand through negotiations with the cloud service user if no cloud service corresponding to the demand has been detected.

5. The cloud service broker apparatus of claim 3, wherein the service positioning module requests the cloud service provider to allocate a cloud service including at least one of server resources, storage resources, network resources, and installation and configuration of an application service designated by the cloud service user.

6. The cloud service broker apparatus of claim 1, wherein the life cycle management unit comprises a service/resource monitoring module for monitoring and managing status of a cloud service contracted between a cloud service user and a cloud service provider and resource status of the cloud service.

7. The cloud service broker apparatus of claim 1, wherein the life cycle management unit comprises:
a service management/control module for monitoring status of a service for a cloud service user, the service being positioned and performed in the cloud service provider at a request of the broker intermediary unit; and
a service resource management module for monitoring status of resources of cloud services positioned and performed in a cloud service provider at the request of the broker intermediary unit, the resources including at least one of server resources, storage resources, and network resources.

8. The cloud service broker apparatus of claim 1, further comprising a connection management unit for managing connections between multiple cloud service providers that provide heterogeneous cloud services and a cloud service user.

9. The cloud service broker apparatus of claim 8, wherein the connection management unit comprises:
a common cloud interface module for providing a single interface that connects to multiple cloud services provided by the multiple cloud service providers; and
a heterogeneous cloud connection proxy module for switching an interface from the single interface provided by the common cloud interface module to an interface of a cloud service.

10. The cloud service broker apparatus of claim 1, further comprising a business support unit for managing usage of the cloud service based on monitoring results of the life cycle management unit and charging cloud service usage expenses to the cloud service user.

11. The cloud service broker apparatus of claim 1, further comprising an application image management unit for storing and managing an image of an application run by a cloud service positioned in and used by the cloud service user at a request of the broker intermediary unit.

12. The cloud service broker apparatus of claim 1, further comprising a security unit for authenticating a cloud service user and a cloud service provider and examining security vulnerability of each cloud service registered by the operation information management unit.

13. A method for providing a cloud service using a cloud service broker apparatus, comprising:
registering, by the cloud service broker apparatus, cloud services provided from multiple cloud service providers;
receiving, by the cloud service broker apparatus, a demand from a cloud service user;
verifying, by the cloud service broker apparatus, the demand;
detecting, by the cloud service broker apparatus, a cloud service that corresponds to the demand for which the verification has been completed from among the registered multiple cloud services; and
providing, by the cloud service broker apparatus, the detected cloud service by connecting an interface between the detected cloud service and the cloud service user.

14. The method of claim 13, wherein receiving the demand from the cloud service user comprises:
receiving, by the cloud service broker apparatus, a demand that includes at least one of a cloud's position, usage expenses, reliability, system resource specification, and operating system.

15. The method of claim 13, wherein verifying the demand comprises:
performing, by the cloud service broker apparatus, verification including at least one of verification of grammatical mistakes of the demand and verification of whether the demand corresponds to a supportable cloud service.

16. The method of claim 13, wherein detecting the cloud service comprises:
modifying, by the cloud service broker apparatus, the demand through negotiations with the cloud service user if no cloud service corresponding to the demand has been detected;
re-verifying, by the cloud service broker apparatus, the modified demand; and
detecting, by the cloud service broker apparatus, a cloud service corresponding to the demand for which re-verification has been completed.

17. The method of claim 13, wherein detecting the cloud service comprises:
performing, by the cloud service broker apparatus, a trade contract for the detected cloud service between the cloud service user and the cloud service provider;
configuring, by the cloud service broker apparatus, a service specification of the cloud service for which the trade contract has been completed; and
requesting, by the cloud service broker apparatus, the cloud service provider to allocate the cloud service based on the service specification.

18. The method of claim 13, further comprising:
monitoring, by the cloud service broker apparatus, status of the provided cloud service and resource status of the cloud service.

19. The method of claim 18, wherein monitoring the status of the cloud service and resource status of the cloud service comprises:
if the monitored status of the cloud service becomes inconsistent with terms of a Service Level Agreement (SLA), re-subscribing or re-positioning, by the cloud service broker apparatus, a cloud service.

20. The method of claim 18, further comprising:
charging, by the cloud service broker apparatus, cloud service usage expenses based on the monitoring results.
